(19) United States
(12) Patent Application Publication
(10) Pub. No.: US 2012/0145633 A1
(43) Pub. Date: Jun. 14, 2012

(54) ULTRA-SOUND ENHANCED CENTRIFUGAL SEPARATION OF OIL FROM OILY SOLIDS IN WATER AND WASTEWATER

(75) Inventors: David M. Polizzotti, Yardley, PA (US); Abdul Rafi Khwaja, Upper Gwynedd Twp, PA (US)

(73) Assignee: GENERAL ELECTRIC COMPANY, Schenectady, NY (US)

(21) Appl. No.: 12/963,693

(22) Filed: Dec. 9, 2010

(51) Int. Cl. C02F 1/40; C02F 1/36; C02F 1/24; C02F 1/38; C02F 1/44

(52) U.S. Cl. 210/652; 210/748.05; 210/703; 210/708

(57) ABSTRACT

Methods are provided for separating solids containing oily/water of the type normally encountered in SAGD and hydraulic fracturing operations. The solids containing oily/water is subjected to ultrasound separation techniques and mechanical separation operations. The mechanical separation operation may, preferably, comprise centrifugal separation such as that in which the treated solids containing oily/water is separated into a solids fraction, an oil fraction, and a water fraction.

### FIELD OF INVENTION

The present invention pertains to methods for enhancing separation of solids containing oily water including process waters obtained from oil sands mining and hydraulic fracturing natural gas production techniques. More particularly, the invention relates to methods in which ultrasonic energy separation and mechanical separation processes, such as centrifugal separation, are conjointly employed.

### BACKGROUND OF THE INVENTION

Steam assisted gravity drainage (SAGD) methods are commonly employed as an oil recovery technique for producing heavy crude oil and bitumen, especially in oil sands projects. In this method, two parallel horizontal wells are drilled. The upper well injects steam into the geological formation, and the lower well collects the heated crude oil or bitumen that flows out of the formation along with water from the condensation of the injected steam. This condensed steam and oil are pumped to the surface wherein the oil is separated, leaving an oily/water mixture known as “produced water”. Roughly three barrels of this oily and bituminous containing process water are produced per barrel of recovered oil. Recovery and reuse of the water are needed to reduce operational costs and to minimize environmental concerns. The process water is eventually recycled to the steam generators used in the SAGD process, but it must first be clarified and separated from suspended and emulsified oil and bitumen as well as salts and other impurities.

The SAGD produced water normally contains about 1-60% solids and has a temperature of about 95° C. It has accordingly required energy intensive evaporators to provide for effective reuse of this SAGD produced water.

Hydraulic fracturing or fracing may be used to initiate natural gas production in low permeability reservoirs and to restimulate production in older wells. These processes produce millions of gallons of so-called frac water, and involve the injection of sand and chemically heated water to crack and hold open rocks to allow natural gas to surface. While most of this injected hydraulic frac water remains underground, sufficient quantities of same return to the ground surface and are referred to as “flowback” water. This flowback water comprises oil, sand, chemicals, and minerals such as Ca, Na, and chloride. Light non-aqueous phase liquids may be separated from the frac water leaving an underlying contaminated frac water containing oily residue and solids that must be separated prior to discharge of the water in an environmentally acceptable manner.

### SUMMARY OF THE INVENTION

In one exemplary embodiment of the invention, a method of treating oily water is provided wherein the oily water is fed to an ultrasonic generator to subject the oily water to sonic energy wherein a solids fraction and an oily water phase are formed. The oily/water phase also contains minor amounts of solids therein. The oily/water phase containing solids are subjected to a mechanical separation process. In other embodiments of the invention, the mechanical separation process may comprise processes such as filtration, flotation, reverse osmosis, cyclonic, gravity separation, and centrifugal separation processes.

In accordance with one centrifugal separation process that may be used, the oily/water phase containing minor amounts of solids therein is subjected to a swirling vortex force in an elongated cylindrical housing of the centrifugal separator. As a result of this swirling vortex force, the oily/water phase containing minor amounts of solids therein is separated into an oil phase, a water phase, and a third phase including the solids.

In accordance with yet another aspect of the invention, the oily/water may be produced water from a steam assisted gravity discharge (SAGD) operation. In another embodiment, the oily/water may be frac water from a hydraulic fracturing operation.

Another aspect of the invention pertains to the feeding of surfactants, coagulants, and/or flocculants to the oily wastewater.

In another embodiment, the oily feedwater is fed to a reverse osmosis unit to form RO permeate and concentrate. The concentrate is composed of a solids fraction (i) and an oily/water phase (ii) which oily/water phase contains minor amounts of solids therein. The concentrate from the reverse osmosis unit is fed to an ultrasonic generator. A mechanical separation device, downstream from the ultrasonic generator, may then be employed to further separate the concentrate into three phases, namely, a solids phase, an oil phase, and a water phase.

### BRIEF DESCRIPTION OF THE DRAWINGS

FIG. 1 is a schematic process diagram showing one embodiment of the invention; and

FIG. 2 is a schematic process diagram of another invention embodiment.

### DETAILED DESCRIPTION

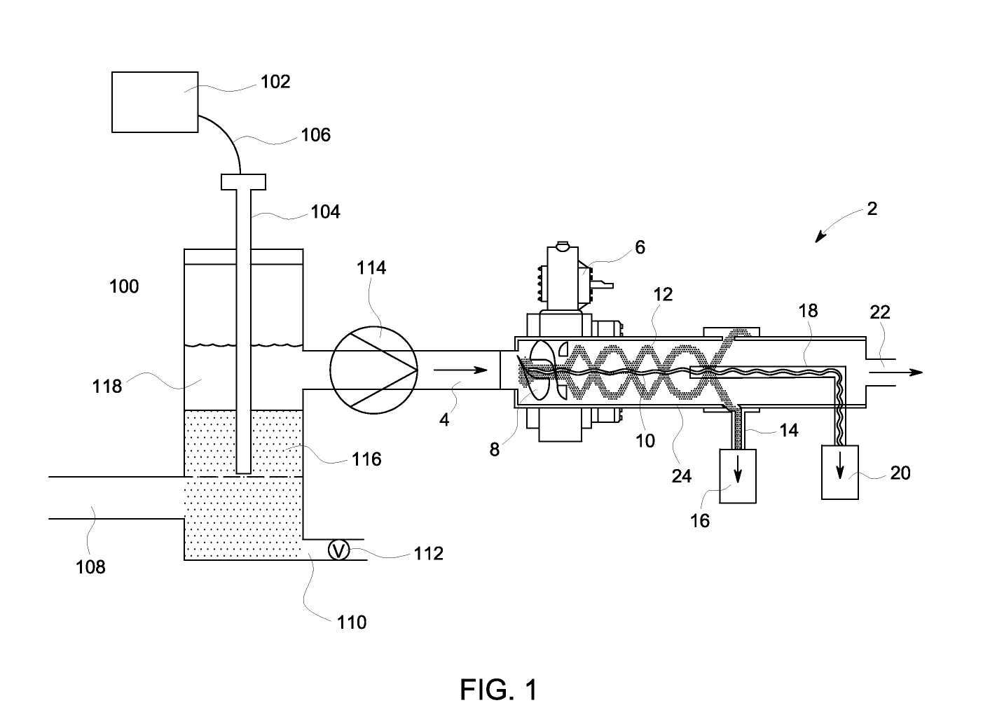

Turning first to FIG. 1, there is shown one embodiment of the invention for treating solids containing oily wastewater of the type described above that may result for example from SAGD and hydraulic fracturing operations. Although these two types of solids containing oily water are specifically mentioned with regard to the specific embodiments described, the artisan will appreciate that a variety of such soil containing oily waters could also be treated such as the oily waters produced in coal bed methane, mining, food, and the drilling industries. In many of these applications, the oily/water to be treated includes a solids component in an amount of about 1 to 60% solids which complicates the desired separation function. The SAGD produced water and frac flowback water provide for especially difficult separation processes in that the solid particles thereof are to a large extent coated or otherwise laden with oil.

As shown in FIG. 1, solids containing oily wastewater is admitted to ultrasonic separator 100 through inlet 108. The separator is operatively connected to sonic generator 102 via wire 106 connecting the generator to acoustic horn 104. One exemplary ultrasonic separator that may be mentioned is the 500 W-Ultrasonic Processor manufactured by Heat Systems Ultrasonics. It is important that the sonication be conducted so as to provide acoustic turbulence in the oily wastewater without resulting in cavitation. Cavitation is defined as the creation of substantial bubbles of gas or vapor and subsequent collapse or implosion of the bubbles resulting in high energy densities. Accordingly, the application of sonic energy to the oily wastewater should be such as not to result in cavitation.

The artisan will appreciate that a variety of ultrasonic generators may be chosen for use in accordance with the invention. These generators possess differing geometries and operating parameters such as output energy (i.e., ultrasonic intensity) that is normally measured in units of watts/cm². A wide variety of operating ranges can be chosen for use in the invention provided that cavitation is avoided.

In U.S. Pat. No. 5,658,534, it is reported that cavitation can occur at an ultrasonic intensity exceeding 0.3 w/cm². However, in accordance with the above, it is thought that the ultrasonic intensity range necessary to produce cavitation effects varies over a wide range. The artisan can readily assess various systems and visually observe whether cavitation is or is not occurring. The entire disclosure of U.S. Pat. No. 5,658,534 is incorporated by reference herein. Other sonication devices are reported in U.S. Pat. Nos. 5,017,281 and 6,110,359. These patents are also herein incorporated by reference.

The solids containing oily water is thus subjected to sonic energy in the device 100 and forms a solids phase shown at 116 which solids may be removed from the separator via outlet conduit 110 shown in association with valve 112. This solids phase 116 comprises substantially all solid particles with some of the solid particles still being laden with oil. The remaining, separated phase 118 may be characterized as including an oily water medium still having a significant amount of solids, including oil laden solids suspended and dissolved therein.

The solids containing oil/water phase 118 is then fed through conduit 4, regulated via a variable speed pump 114 or the like to the upstream entry end of a mechanical separation device. As shown in FIG. 1, the mechanical separator functions via centrifugal separation techniques and, as shown, is a Voraxial® separator available from Environ Voraxial Technology, Fort Lauderdale, Fla.

In FIG. 1, the Voraxial® separator 2 comprises an elongated, enclosed cylindrical housing 24 having an upstream inlet 4 and downstream outlet 22. A Voraxial® drive unit 6 is operatively connected to a plurality of blade members 8 to impart rotation thereto to create a centrifugal acceleration force to the fluid medium fed to the housing as it travels from an upstream direction from the inlet 4 to the outlet 22. The rotating blades 8 cause the medium to spin about the central axis of the housing 24. The fluid is spun and separated into component fluids and solids at different radial locations depending upon the specific gravity thereof. A high velocity swirling action is imparted to the oil water as it proceeds axially from the upstream feed inlet towards the downstream end by means of the rotatable blades. A lower pressure area is created along the longitudinal axis of the flow line to thereby generate a high centrifugal force as the fluids travel axially and cause the fluid component having the highest specific gravity to migrate to the perimeter of the housing.

In the treatment of solids containing oily wastewater such as SAGD and frac produced water in the Voraxial® separator, the lightest fraction, oil, is forced via free Voraxial® action and Bernoulli pressure forces into a tight cylindrical core flow as shown at 10 for subsequent separation from the fluid medium through centrally disposed oil collection tube 18 emptying into oil reservoir 20. The heaviest components 12 such as the bitumen and associated solids are collected via a trap 14 located along the circumferential surface of the housing for collection in vessel 16 or the like. The water separated from the oily water fluid medium exits at downstream exit 22 for disposal, recycling into the system, or polishing prior to possible use as polished influent water for reverse osmosis membrane treatment or other applications. The effluent water from 22 may, for example, be used for potable applications, possible recycle for use to generate steam for SAGD operations or recycle use as a fracing water. Voraxial® separators of the type diagrammatically depicted in FIG. 1 are disclosed for example in U.S. Pat. Nos. 6,248,231 and 5,084,189. The disclosures of these patents are incorporated by reference herein.

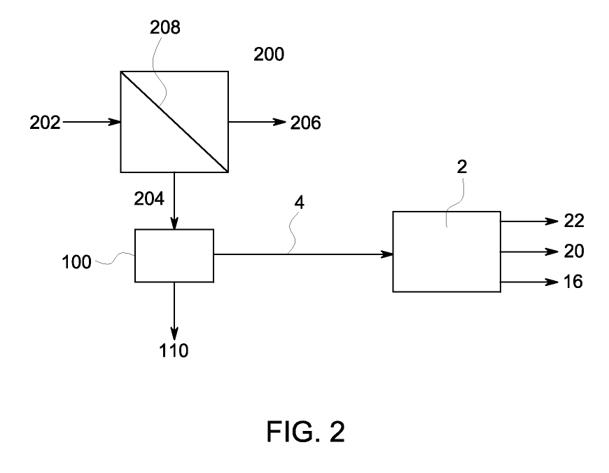

Turning now to FIG. 2, another exemplary embodiment of the invention is shown schematically. Here, solids containing oily water, such as SAGD produced water or frac flowback water is fed to reverse osmosis unit 200 via inlet 202. The RO unit includes RO membrane 208 which separates the solids containing oily water into a permeate 206 that may for example be used for potable water supply, high purity water for electronic industry applications, steam production, or the like. The concentrate or retentate from the RO unit is then fed as shown at 204 to a sonication separation device shown schematically as unit 100 wherein it is subjected to ultrasonic excitation as previously described to form a substantially solids phase that exits the unit 100 at 110 and an oil/water/solids phase that is admitted via inlet 4 to a mechanical separation unit, such as a Voraxial® separator, as previously described, to separate the oil/water/solids phase into three fractions, namely, a “heavies” fraction 16, light fraction 20, and middle fraction 22, all based on the specific gravity of the components. Similar to the embodiment shown in FIG. 1, the heavies fraction contains mostly solids 16 with the light fraction 20 consisting predominantly of oil with the remaining liquid or water phase shown diagrammatically being separated at 22.

With regard to the mechanical separation devices that may be used, the centrifugal action separators such as the “Voraxial®” separator discussed above are preferred. However, the artisan will readily appreciate that filtration, flotation, reverse osmosis, and gravity separation techniques may also be employed.

Additionally, one can readily perceive that the exemplified ultrasonic separation step followed by the centrifugal separation step could be followed by subsequent separation steps such as ultrafiltration, nanofiltration, microfiltration, or reverse osmosis techniques to further refine or purify the aqueous phase exiting from the centrifugal separation step.

Additionally, surfactants, coagulants, and flocculating agents may be added to the solids containing oily phase at one or more stages throughout the system. Exemplary surfactants that may for example be mentioned include non-ionic and anionic surfactants.

Suitable anionic surfactants include alkyl aryl sulfonic acids, alkyl sulfonic acids, alkenyl sulfonic acids, sulfonated alkyls, sulfonated monoglycerides, and sulfated fatty esters. Exemplary anionic surfactants include the long chain alpha olefin sulfonates; water soluble salts of alkenyl sulfonic acid such as the sodium salt of C₁₄-C₁₆ alphaolefin sulfonates; water soluble alkyl aryl sulfonic acid salts such as sodium alkylnaphthalene sulfonate and sodium alkyl benzene sulfonate; water soluble salts of sodium lauryl sulfate; and water soluble salts of sulfated monoglyceride. Suitable nonionic surfactants include ethylene oxide condensates of nonyl- or octylphenol, ethylene oxide condensates of straight chain alcohols, fatty acid amides, and coconut alkanolamides. These surfactants can be added, for example, to the solids containing oily/water phase in an amount of about 0.5-500 ppm.

As to the coagulants and flocculants that may be mentioned, a myriad of these may be mentioned as exemplary including those based on reaction of epihalohydrins with secondary amines such as those involving epichlorohydrin/dimethylamine, acrylamide polymers and copolymers. Exemplary acrylamide copolymers include cationic copolymers based on acrylamide monomeric repeat units, and repeat units based on allytrialkylammonium chloride, diallyl dialkyl ammonium chloride or ammonium alkyl (meth)acrylates. Acrylamide/acrylic acid copolymers may also be mentioned. The coagulants and/or flocculants may also be fed in an amount of about 0.5-500 ppm based upon 1 million parts of the aqueous medium.

Although the present invention has been described with preferred embodiments, it is to be understood that modifications and variations may be resorted to, without departing from the spirit and scope of this invention, as those skilled in the art will readily understand. Such modifications and variations are considered to be within the purview and scope of the appended claims.

1. Method of treating oily water comprising: a) feeding said oily water to an ultrasonic generator to subject said oily water to sonic energy therein, wherein a solids fraction (i) and an oily/water phase (ii) are formed with said oily/water phase also containing minor amounts of solids therein, and b) subjecting said oily/water phase (ii) to a mechanical separation process.

2. Method as recited in claim 1 wherein said mechanical separation process is a member selected from the group consisting of filtration, flotation, reverse osmosis, cyclonic, gravity separation and centrifugal separation processes.

3. Method as recited in claim 1 wherein said mechanical separation process comprises centrifugal separation, said centrifugal separation process comprising subjecting said oily/water phase (ii) to a swirling vortex force in an elongated cylindrical housing of a centrifugal separator, and as a result of said swirling vortex force, separating said oily/water phase (ii) into an oil phase, a water phase and a third phase including the solids of said oily/water phase (ii).

4. Method as recited in claim 3 wherein said oily water is produced water from a steam assisted gravity drainage (SAGD) operation.

5. Method as recited in claim 3 wherein said oily water is frac water from a hydraulic fracturing operation.

6. Method as recited in claim 3 further comprising feeding a surfactant to said oily water.

7. Method as recited in claim 3 further comprising feeding a coagulant to said oily water.

8. Method as recited in claim 3 further comprising feeding a flocculant to said oily wastewater.

9. Method as recited in claim 3 wherein prior to said step a), said oily feedwater is fed to a reverse osmosis unit to form RO permeate and concentrate, said concentrate composed of said solids fraction (i) and said oily/water phase (ii) and feeding said concentrate from said reverse osmosis unit to said ultrasonic generator.
